(19) United States
(12) Patent Application Publication
(10) Pub. No.: US 2003/0169963 A1
(43) Pub. Date: Sep. 11, 2003

(54) Mechanical optical switch

(76) Inventor: Mingbao Zhou, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/198,338

(22) Filed: Jul. 16, 2002

(30) Foreign Application Priority Data
Mar. 6, 2002 (TW) 91202525

(51) Int. Cl. G02B 6/35; G02B 6/32

(52) U.S. Cl. 385/22; 385/33

(57) ABSTRACT

An optical switch for switching light beams from an optical input fiber among a plurality of output optical fibers includes a mounting frame (5), an optical input device (1) having an input optical fiber (111) for emitting light signals and an optical output device (4) having a plurality of output optical fibers (411) for receiving the emitted light signals out of the optical switch. The input device has a first collimating lens (12). A switch assembly (2) includes a lens holder (22) and a plurality of second collimating lenses (21) is mounted in the lens holder. Each of the second collimating lenses has a different geometry. A driving device (3) drives the lens holder to rotate. Thus, when a preselected collimating lens is aligned between the optical input device and the optical output device, a unique beam optical path is formed and an input light signal switches to a different output fiber.

### BACKGROUND OF THE INVENTION

1. Field of the Invention

This invention relates generally to optical switches, and more particularly to a mechanical optical switch having an array of lenses mounted in a rotatable lens holder, which switches a beam from an input optical fiber among a plurality of output optical fibers.

2. Description of the Related Art

In conventional optical switches, high insertion losses and optical directivity are problems. Referring to FIG. 5, U.S. Pat. No. 5,907,650 discloses an optical switch comprising a platform 600, an input assembly 610, a plurality of output assemblies 620 and a reflector assembly 630. The platform 600 is used for supporting and fixing the input assembly 610, the plurality of output assemblies 620 and the reflector assembly 630. The input assembly comprises an input fiber 611 and a GRIN lens 612. Each output assembly comprises an output fiber 621 and a GRIN lens 622. The reflector assembly 630 is located in a center hole 601 of the platform 600 and comprises a reflector 631 and a base 632 for fixing the reflector 631. A hole 633 is defined in the base 632 for accepting a driving device (not shown). The input assembly 610 is perpendicular to the platform 600 and is at a forty-five degree angle with respect to the reflector 631. The plurality of output assemblies are disposed parallel to and on the platform 600, in a circular arrangement surrounding the reflector assembly 630. The reflector assembly 630 is rotated by the driving device to selectively output light from the input fiber 611 to one selected output fiber 621. Additionally, the reflector assembly 630 can direct input light from a selected output fiber 621 into the input fiber 611.

In view of the above, it is desired to provide an optical switch which has relatively few parts, which accomplishes optical path switching with low insertion losses and with a simpler operating mechanism, and which can be produced at low cost.

An example of an optical switch is disclosed in co-pending application, with an unknown Ser. No. filed Jul. 8, 2002, having the same title, the same applicant and the same assignee as the invention.

### SUMMARY OF THE INVENTION

To achieve the above objects, a mechanical optical switch in accordance with the present invention for switching light beams from an optical input fiber among a plurality of output optical fibers includes a mounting frame, an optical input device having an input optical fiber for emitting light signals and an optical output device having a plurality of output optical fibers for receiving the emitted light signals out of the optical switch. The input device has a first collimating lens. A switch assembly includes a lens holder and a plurality of second collimating lenses is mounted in the lens holder. Each of the second collimating lenses has a different geometry. A driving device drives the lens holder to rotate. Thus, when a pre-selected collimating lens is aligned between the optical input device and the optical output device, a unique beam optical path is formed and an input light signal switches to a different output fiber.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is a perspective view of an optical switch in accordance with the present invention;

FIG. 2 is a cross section view taken along line II-II of FIG. 1;

FIGS. 3 and 4 are light path schematic views of the optical switch of FIG 1; and

FIG. 5 is a perspective view of an optical switch in accordance with the prior art.

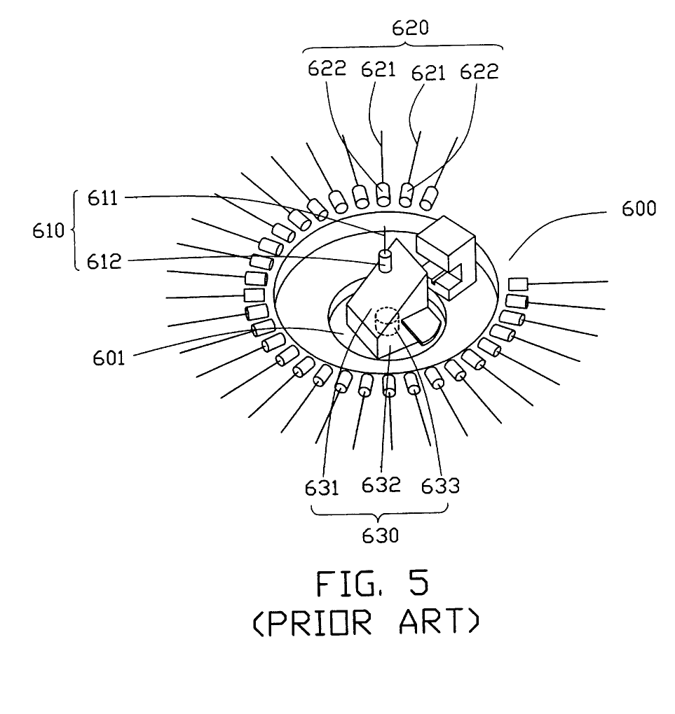

### DETAILED DESCRIPTION OF THE PREFERRED EMBODIMENT

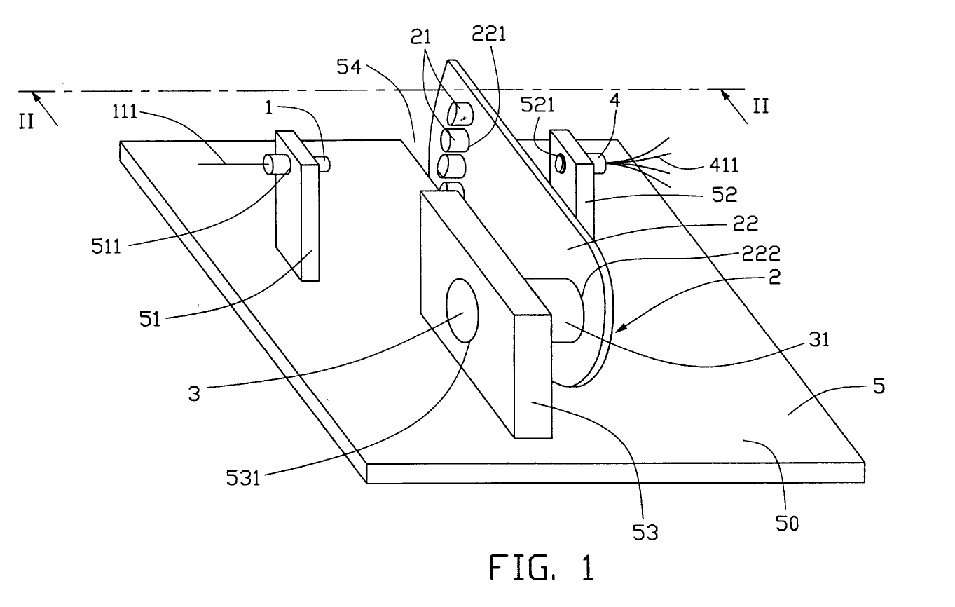

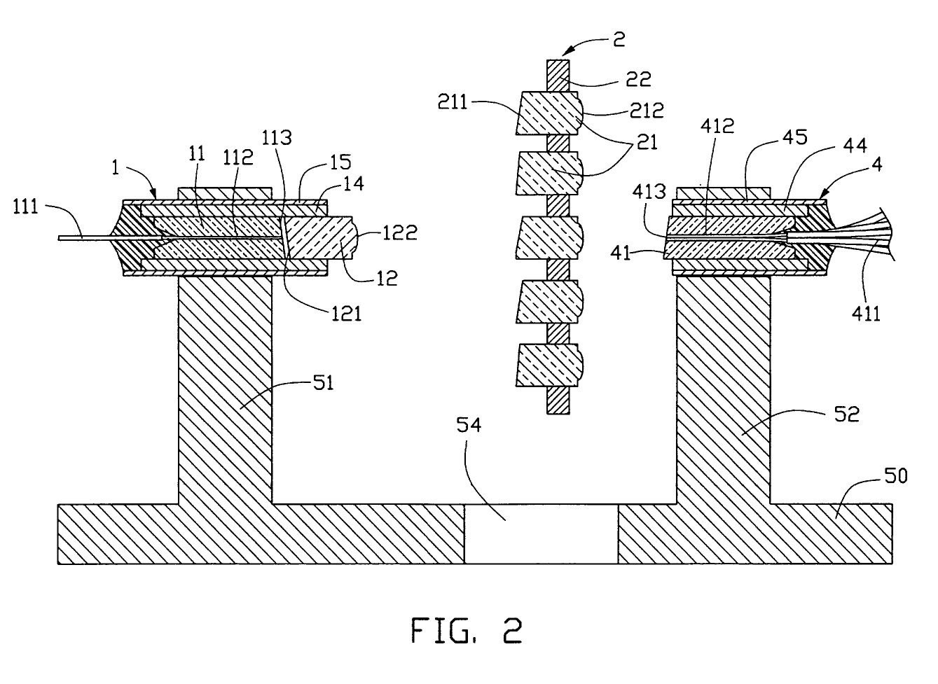

Referring to FIGS. 1 and 2, an optical switch in accordance with a preferred embodiment of the present invention comprises a mounting frame 5, an input device 1, an output device 4, a switching assembly 2, and a driving device 3.

Referring to FIG. 1, the mounting frame 5 includes a substrate 50, a first supporting plate 51, a second supporting plate 52, a third supporting plate 53 and an opening 54. The supporting plates 51, 52, and 53 respectively extend upwardly from the substrate 50. The first and second supporting plates 51, 52 each have a through hole 511 and 521 respectively receiving the input device 1 and output device 4 therein. The third supporting plate 53 has a mounting hole 531 for assembling the driving device 3 thereon. The opening 54 is defined between the supporting plates 51 and 52.

Referring to FIG. 2, the input device 1 includes an input optical fiber 111, an input ferrule 11, and a first collimating lens 12. The input ferrule 11 is substantially cylindrical in shape and defines a channel 112 therethrough along a longitudinal axis thereof, through which the input optical fiber 111 extends. An end face 113 of the input optical fiber 111 is ground flat, coplanar with an end face 113 of the input ferrule 11, at an angle of 6-8 degrees from a hypothetical plane constructed normal to a longitudinal center line of the input optical fiber 111. The first collimating lens is preferably a molded lens, which is substantially cylindrical in shape. An end face 121 of the first collimating lens 12 is mounted parallel to the end face 113 of the input ferrule 11, and an opposite end face 122 has a non-spherical shape. The first collimating lens 12 can be replaced by other optical elements having a collimating function. The input ferrule 11 is aligned with the first collimating lens 12, and both are held in a quartz sleeve 14, with a front portion of the first collimating lens 12 extending out of the quartz sleeve 14. The quartz sleeve 14 is received into a metal sleeve 15 for protection.

The output device 4 includes a plurality of output optical fibers 411, and an output ferrule 41 to receive the output optical fibers 411. The output ferrule 41 is also cylindrical in shape and defines a channel 412 therethrough along a longitudinal axis thereof. An end face 413 is ground flat at an angle of 6-8 degrees from a hypothetical plane constructed normal to a longitudinal centerline of the output ferrule. The ferrule 41 is retained into a quartz sleeve 44, and the sleeve 44 is retained into a metal sleeve 45 for protection.

The switching assembly 2 includes a plurality of second collimating lenses 21 and a lens holder 22. Each second collimating lens 21 is substantially like the first collimating lens 12 in structure, and is also a cylindrical in shape, and has a slanted end face 211 and a non-spherical end face 212. The degree of slant of each end face 211 is different, therefore, a beam of light aimed along a longitudinal axis of a second collimating lens at the end face 211 passing through the different second collimating lens 21 would be directed along a different path by each lens and further would converge to a different output optical fiber 411. The second collimating lenses 21 can be replaced by any of a number of other optical elements having a collimating function. In addition, the switching assembly 2 can also use an array of lenses, each of which has a different reflection index, or can use a singe optical device that can be turned to different angles. The lens holder 22 is substantially a rectangular shape (See FIG. 1), with two ellipsoidal ends. A plurality of through holes 221 are defined through one end of the lens holder 22, arranged along an arc, to receive the second collimating lenses 21 therein, and a mounting hole 222 is defined therethrough an opposite end of the lens holder 22 to fix to the driving device 3.

Referring back to FIG. 1, the driving device 3 includes a connecting pole 31 and an outer driver (not shown). The connecting pole 31 is mounted between the second supporting plate 53 and the lens holder 22. When the outer driver drives the connecting pole 31, the lens holder 22 moves.

Referring to FIGS. 1-3, in assembly, an outer sheath (not labeled) of the input optical fiber 111 and of each of the plurality of output optical fibers 411 is stripped off and a core (not labeled) of the input optical fiber 111 is inserted into and held within the channel 112 of the input ferrule 11, and cores (not labeled) of the output optical fibers 411 are inserted into and held within the channel 412 of the output ferrule 41. The input device 1 is assembled into the through hole 511 of the first supporting plate 51. Similarly, the output device 4 is assembled into the through hole 521 of the second supporting plate 52, aligned with and facing a front end of the input device 1. The lens holder 22, with the second collimating lenses 21 mounted in the corresponding through holes 221 is then fixed to the connecting pole 31, and the mounting hole 222 of the lens holder 22 is fixed on one end of the connecting pole 31. And then, the opposite end of the connecting pole 31 is assembled into the mounting hole 531 of the third supporting plate 53.

Referring to FIGS. 1-2, in operation, the driving device 3 drives the connecting pole 31 to move the lens holder 22 up and down in the opening 54. Thus, the different lenses 21 are selectively positioned to align with the input device 1 and the output device 4.

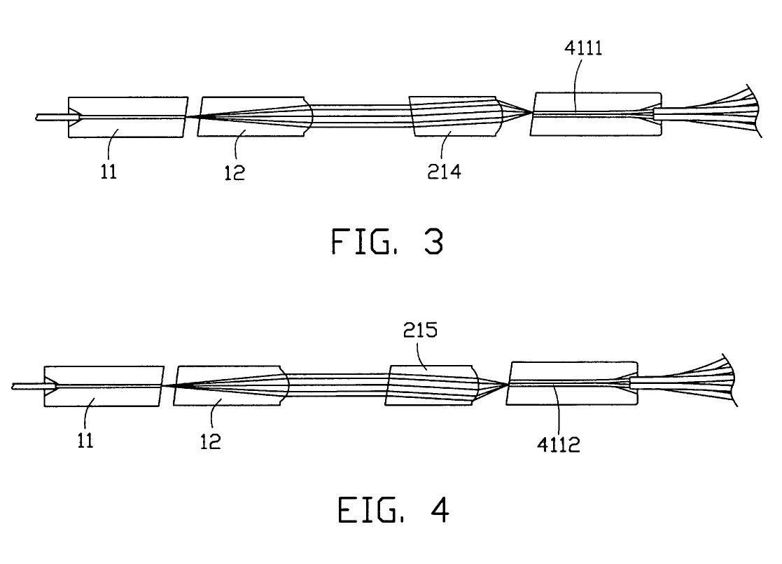

FIGS. 3-4 schematically illustrate the switching action of the optical switch. In particular, referring to FIG. 3, a beam of light is shown being emitted from the input optical fiber 111 and passing consecutively through the first collimating lens 12, an individual second collimating lens 214, to an individual output fiber 4111. Concentrating on the individual ray lines, the light beam is expanded and collimated by the first collimating lens 12, then travels as parallel rays before, and within the second collimating lens 214. The parallel rays are then focused by the non-spherical end faces of the second collimating lens 214 to covers the faces of the individual output fiber 4111. The design and mounting of the second collimating lens 214 assures that the focal point of the focused beam will be on the output fiber 4111.

Note that in FIG. 4, the second collimating lens 214 is replaced by a different second collimating lens 215 of the array of the second collimating lenses 21. The action of the second collimating lens 215 results in a shift of the light beam such that the beam focal point is on a different output fiber 4112. Substitution of the second collimating lens 214 with the second collimating lens 215 thus switches the light signal to a new output fiber 4112. A similar switching process occurs for each change of second collimating lenses 21, for the input fiber 111 and each output fiber 411.

Note that the replacement of the second collimating lens 214 with the second collimating lens 215 is performed by the driving device 3 moving the lens holder 22 until the second collimating lens 215 aligns with the input device 1, and the output device 4. In a similar way, the driving device 3 drives the lens holder 22 to position each selected lens 21 between the input device 1 and the output device 4. Each different lens 21 results in the beam from the input optical fiber 111 being focused on a different output optical fiber 411. Thus, the driving device 3 accomplishes optical switching.

It should be understood that various changes and modifications to the presently preferred embodiment described herein will be apparent to those skilled in the art. Such changes and modifications may be made without departing from the spirit and scope of the present invention and without diminishing the present invention's advantages. Thus, it is intended that such changes and modifications be covered by the appended claims.

1. An optical switch comprising:
an optical input device being adapted to convey optical signals into the optical switch, including an input ferrule receiving an input optical fiber therein;
an optical output device being adapted to convey the optical signals out of the optical switch, the optical output device being aligned with the optical input device and including an output ferrule receiving a plurality of output optical fibers; and
a plurality of collimating lenses mounted in a rotatable lens holder, each collimating lens having different geometry;
wherein when one of the plurality of collimating lenses is aligned with the optical input device and the optical output device, a light beam from the optical input device directed through the collimating lens is bent along a unique path to one of the output optical fibers of the optical output device.

2. The optical switch as described in claim 1, wherein the optical input device further comprises a collimating lens for collimating the light beam from the input optical fiber.

3. The optical switch as described in claim 2, wherein said collimating lens is a molded lens and one of the end surfaces of the collimating lens has a non-spherical shape.

4. The optical switch as described in claim 1, wherein a plurality of through holes is defined in the lens holder for holding the collimating lenses therein.

5. The optical switch as described in claim 1, wherein the collimating lenses mounted in the lens holder are molded lens and one end surface of each has a sloped, planar surface, and an opposite end surface has a no-spherical shape.

6. The optical switch as described in claim 5, wherein an angle of each sloped, planar surface is different.

7. The optical switch as described in claim 1, further comprising a driving device for driving the lens holder to rotate, the driving device including a driver and a connecting pole.

8. The optical switch as described in claim 1, further comprising a mounting frame for retaining the optical input device, the optical output device, the lens holder and the driving device.

9. The optical switch as described in claim 8, wherein the mounting frame further comprising three supporting plates projecting upwardly from the mounting frame, the supporting plates respectively support the optical input device, the optical output device and the lens holder thereon.

10. The optical switch as described in claim 8, wherein an opening is defined in the mounting frame for passage of the lens holder.

11. The optical switch as described in claim 1, wherein the collimating lenses are arranged in the lens holder shaped along an arc.

12. The optical switch as described in claim 1, wherein the input ferrule in the input device and output ferrule in the output device are respectively received in a quartz sleeve, and said sleeves are respectively received in a metal sleeve.

13. An optical switch adapted to switch a light beam coming from an input optical fiber among a plurality of output optical fibers comprising:
a mounting frame including three supporting plates, the mounting frame defining an opening therethrough;
an input optical device mounted on a first supporting plate, including an input ferrule and a collimating lens, and an input optical fiber received in the input ferrule;
an output optical device mounted on a second supporting plate opposite to the input optical device, and the output optical device including an output ferrule terminating a plurality of output optical fibers;
a switch device including a lens holder;
a plurality of collimating lenses mounted in the lens holder, each collimating lens having a slanted end surface at one end and a non-spherical end surface at an opposite end, and each slanted end surface having a different inclined angle; and
a driving device assembly mounted on a third supporting plate, the driving device assembly including a driving device and a connecting pole, the driving device driving the connecting pole to rotate, the connecting pole driving the switch device to rotate;
wherein, when a selected collimating lens is aligned with the input and output optical devices, a light beam from the input optical device directed through the selected collimating lens is bent along a unique path to arrive at the output optical device.

14. An optical switch comprising:
an optical input device being adapted to convey optical signals into the optical switch, including an input ferrule receiving an input optical fiber therein;
an optical output device being adapted to convey the optical signals out of the optical switch, the optical output device being generally aligned with the optical input device and including an output ferrule receiving a plurality of output optical fibers; and
a plurality of collimating lenses mounted in a moveable lens holder, each collimating lens having different geometries; wherein
when one of the plurality of collimating lenses is aligned with the optical input device and the optical output device, a light beam from the optical input device directed through said one collimating lens is bent along a unique path to corresponding one of the output optical fibers of the optical output device.

15. The switch as described in claim 14, wherein said lens holder is moved in rotation.
